(19) United States
(12) Patent Application Publication
(10) Pub. No.: US 2026/0228315 A1
(43) Pub. Date: Aug. 6, 2026

(54) Identity Verification System and Method Based on Hardware Sensing

(71) Applicant: ViewSonic International Corporation, New Taipei City (TW)

(72) Inventor: Shih-Feng Chen, New Taipei City (TW)

(73) Assignee: ViewSonic International Corporation, New Taipei City (TW)

(21) Appl. No.: 19/089,013

(22) Filed: Mar. 25, 2025

(30) Foreign Application Priority Data
Feb. 4, 2025 (TW) 114103919

(51) Int. Cl. G06F 21/32

(52) U.S. Cl. CPC G06F 21/32; H04W 12/00; H04W 12/06; H04W 12/12; H04W 12/33

(57) ABSTRACT

An identity verification method based on hardware sensing includes obtaining dynamic data of a signatory performing a signature process by a sensing device; obtaining a feature information from the dynamic data, wherein the feature information includes a movement feature, an interaction feature, a posture feature, or a biomechanical feature; comparing the feature information with an authentication reference data to generate a comparison result; and determining authenticity of the signature process performed by the signatory based on the comparison result.

### BACKGROUND OF THE INVENTION

### 1. Field of the Invention

The present invention relates to an identity verification system and method based on hardware sensing, and more particularly, to an identity verification system and method using a sensing device to sense dynamic data during a signature process and determine the authenticity of signatures accordingly.

### 2. Description of the Prior Art

Traditional identity verification methods primarily rely on static signature comparison. For example, when signing documents, verification personnel visually compares the current signature with pre-stored signature templates. This comparison manner depends on the experience and judgment of the verification personnel, making it prone to subjective errors. Moreover, comparison of static signature cannot reflect dynamic features during the signing process, such as signing speed and stylus pressure, making it susceptible to forgery.

With technological advancement, electronic signature pads have been widely applied. However, the electronic signature pads can only record two-dimensional signature information without verification of signature process, making it difficult to prevent imitation by others. Although the development of biometric recognition technologies (such as fingerprint recognition, facial recognition, iris recognition, etc.) has provided new solutions for identity verification, they are still static information. Additional or specialized hardware is required to support the identity verification process and cannot be effectively integrated.

Therefore, providing a more reliable identity verification mechanism and preventing defects of static verification have become an objective of the industry.

### SUMMARY OF THE INVENTION

Therefore, the present invention is to provide an identity verification system and method based on hardware sensing, to provide a more reliable identity verification mechanism.

An embodiment of the present invention discloses an identity verification method based on hardware sensing, which comprises obtaining dynamic data of a signatory performing a signature process by a sensing device; obtaining a feature information from the dynamic data, wherein the feature information includes a movement feature, an interaction feature, a posture feature, or a biomechanical feature; comparing the feature information with an authentication reference data to generate a comparison result; and determining authenticity of the signature process performed by the signatory based on the comparison result.

Another embodiment of the present invention discloses an identity verification system based on hardware sensing, which comprises a sensing device; a processing unit, coupled to the sensing device; and a storage unit, coupled to the processing unit and storing a program code, wherein the program code instructs the processing unit to execute an identity verification method, and the identity verification method includes using the sensing device to obtain dynamic data of a signatory performing a signature process; obtaining a feature information from the dynamic data, wherein the feature information includes a movement feature, an interaction feature, a posture feature, or a biomechanical feature; comparing the feature information with an authentication reference data to generate a comparison result; and determining authenticity of the signature process performed by the signatory based on the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of an identity verification system according to an embodiment of the present invention.

FIG. 2 shows a schematic diagram of an identity verification process according to an embodiment of the present invention.

FIG. 3A shows a schematic diagram of a pen-type sensor according to an embodiment of the present invention.

FIG. 3B shows a schematic diagram of a bracelet-type sensor according to an embodiment of the present invention.

FIG. 3C shows a schematic diagram of a ring-type sensor according to an embodiment of the present invention.

FIG. 4 shows a functional block diagram of a sensing device according to an embodiment of the present invention.

### DETAILED DESCRIPTION

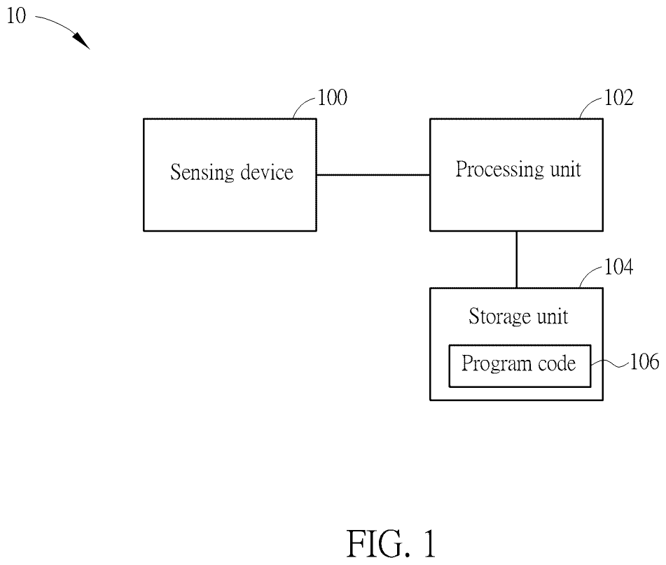

Please refer to FIG. 1, which shows a schematic diagram of an identity verification system 10 according to an embodiment of the present invention. The identity verification system 10 verifies the authenticity of a signatory's signature based on hardware sensing, and includes a sensing device 100, a processing unit 102, and a storage unit 104. In practical operation, physical signature is not necessary. The sensing device 100 can be or include one or more of gyroscope, pressure sensor, and button, for obtaining various dynamic information generated by the signatory during the signature process, including but not limited to velocity changes, acceleration changes, rotation angles, temperature, pressure, or button trigger conditions. The processing unit 102 is coupled to the sensing device 100 so as to receive and process the dynamic data. The processing unit 102 can be a microprocessor, digital signal processor, or other processor with computational capabilities. The storage unit 104 is coupled to the processing unit 102 and stores a program code 106 that instructs the processing unit 102 to execute an identity verification process 20 for dynamic data capture and analysis. The identity verification system 10 can not only verify signature authenticity but also be used for account login on personal mobile devices, robots, or robotic dogs, or for controlling mobile devices, robots, or robotic dogs.

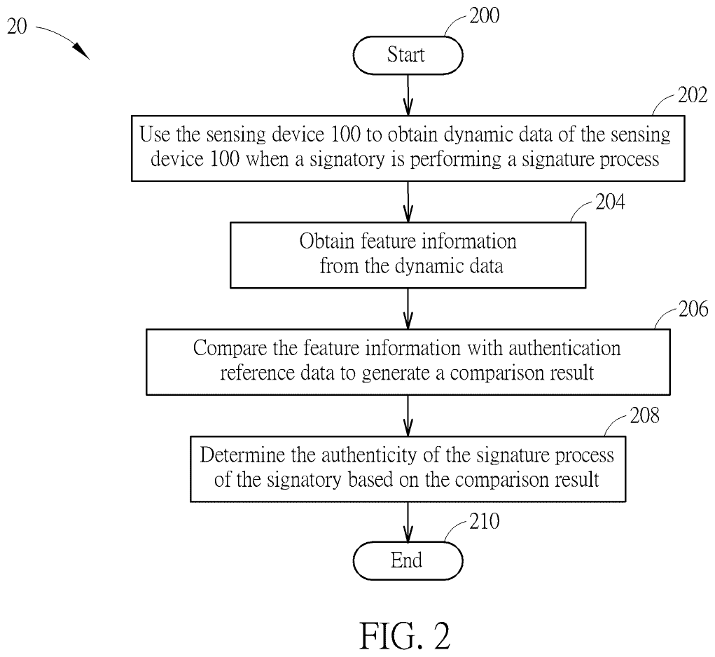

Specifically, please refer to FIG. 2, which shows a schematic diagram of the identity verification process 20. The identity verification process 20 includes the following steps:

Step 200: Start.

Step 202: Use the sensing device 100 to obtain dynamic data of the sensing device 100 when a signatory is performing a signature process.

Step 204: Obtain Feature Information From the Dynamic data.

Step 206: Compare the feature information with authentication reference data to generate a comparison result.

Step 208: Determine the authenticity of the signature process of the signatory based on the comparison result.

Step 210: End.

According to the identity verification process 20, the identity verification system 10 obtains dynamic data of the signatory in real-time through the sensing device 100 during the signature process (Step 202). The processing unit 102 analyzes the dynamic data to obtain the feature information (Step 204). For example, the feature information includes movement features, interaction features, posture features, or biomechanical features. Then, the identity verification system 10 can compare the obtained feature information with pre-stored authentication reference data (Step 206) to determine the authenticity of the signature process of the signatory (Step 208). In brief, the dynamic data of the signature process obtained by the sensing device 100 is analyzed and compared for verifying signature authenticity. The signature process contains a plurality of dynamic information that reflects personal characteristics such as writing habits and multi-dimensional hand features, which is difficult for others to fully imitate. Compared to traditional identity verification mechanisms that only verify static handwriting, the embodiment of the present invention enhances the accuracy and reliability of identity verification.

Specifically, in Step 202, the identity verification system 10 uses the sensing device 100 to detect and obtain dynamic data of the signatory during the signature process in real-time. To detect the dynamic data, the sensing device 100 can be equipped but not limited with a gyroscope, a pressure sensor, or a button for obtaining dynamic data such as velocity changes, acceleration changes, rotation angles, temperature, pressure, or button trigger conditions. The dynamic data can reflect the signatory's unique motion characteristics, such as holding habits, writing methods, preset keys, and other information, which can be served as a basis for identity verification.

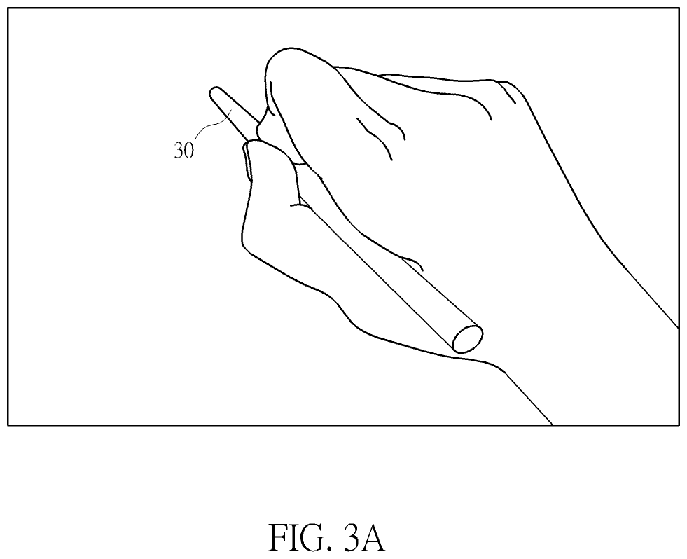

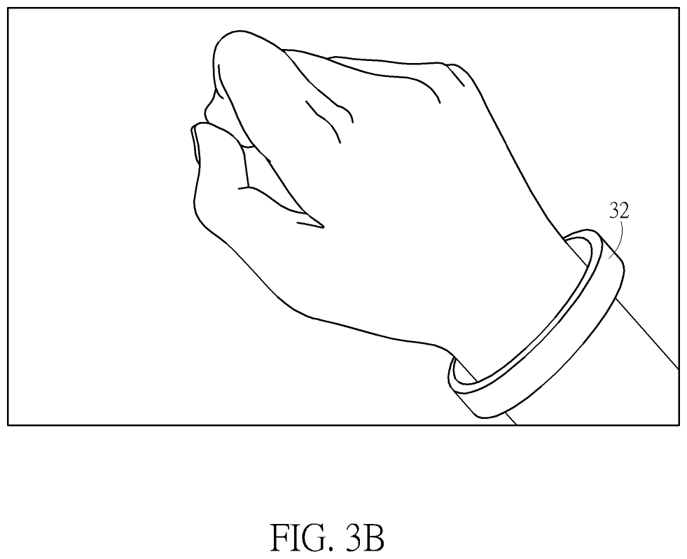

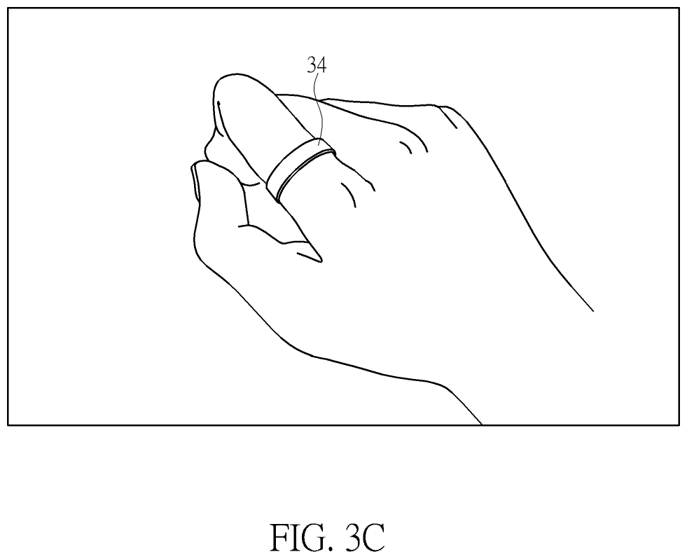

The implementation of the sensing device 100, such as the equipped sensors, appearance, material, and manufacturing method, is not limited and can be adjusted appropriately, as long as it can correctly detect the dynamic data of the signature process of the signatory according to system requirements. Moreover, during the signature process, the signatory does not need to produce an actual physical signature and can freely write in three-dimensional space. For example, in one embodiment, as shown in FIG. 3A, the sensing device 100 is a pen-type sensor 30, and the signatory holds the pen-type sensor 30 to sign. The pen-type sensor 30 can detect the dynamic data of the signatory signing in a pen-holding manner, but does not need to produce a physical signature. That is, both ends of the pen-type sensor 30 are free ends, and the detected dynamic data is generated when both ends of the pen-type sensor 30 are in a free state. In another embodiment, as shown in FIG. 3B, the sensing device 100 is a bracelet-type sensor 32, and the signatory wears the bracelet-type sensor 32 to sign, so the bracelet-type sensor 32 can detect the dynamic data of the signatory's wrist during signing. In another embodiment, as shown in FIG. 3C, the sensing device 100 is a ring-type sensor 34, and the signatory wears the ring-type sensor 34 on an index finger to sign, so the ring-type sensor 34 can detect the dynamic data of the signatory's index finger during signing. In another embodiment, the sensing device 100 can also be configured with a unique hardware identifier that is used to establish exclusive encryption keys to further enhance system security.

In Step 204, the obtained dynamic data is analyzed and processed by the processing unit 102 to obtain feature information. In one embodiment, the processing unit 102 can perform noise reduction processing on the dynamic data to remove noise interference, and then perform normalization processing to facilitate data obtained at different times or in different contexts to be comparable. Furthermore, the processing unit 102 can extract feature vectors from the processed dynamic data as feature information, which can include stroke order of the signature, velocity change patterns, pressure distribution characteristics, or angle change characteristics.

In one embodiment, the feature information can be the movement features when the signatory performs signing, including but not limited to dynamic parameters such as movement distance, movement path, instantaneous velocity, average velocity, maximum velocity, minimum velocity, or acceleration rate changes in two-dimensional or three-dimensional space. These movement features can reflect the signatory's handwriting and unique motion habits and rhythmic characteristics during the signature process.

In another embodiment, the feature information can be the interaction features when the signatory performs signing, such as button-triggered timing, button-pressed duration, button-pressed pressure, or button-pressed sequences. The identity verification system 10 can record interaction patterns between the signatory and the sensing device 100 based on timeline during the signature process, including but not limited to initial stylus pressure, variations of stylus pressure during the signature process, or ending gesture of the signing process. Compared to the movement features, these interaction features are less observable, which can prevent imitation and enhance security.

In another embodiment, the feature information can be the posture features when the signatory performs signing, including but not limited to holding angle, tilt direction, rotational angular velocity, or device stability. These posture features can reflect the signatory's holding habits, such as pen tilt angle range, angle variation patterns during writing, or device vibration frequency.

In another embodiment, the feature information can be the biomechanical features generated by the signatory during the signature process, such as grip force distribution of the sensing device 100, movement trajectory of the pressure center, and grip force changing frequency. These biomechanical features can capture the signatory's unique muscle control patterns and writing habits.

In another embodiment, the feature information can be any combination of the above features. For example, at least one of the movement features, the posture features and the biomechanical features, combined with interaction features can be served as feature information, meaning that the feature information can include the interaction feature paired with at least one of the movement features, the posture features and the biomechanical features. Additionally, the feature information can be time-sequenced combinations of the above features. The identity verification system 10 can record dynamic changes of various features according to a timeline and analyze relationships between these features, and can optionally form composite information (increasing key complexity), such as correlations between movement speed and grip force, temporal relationships between posture changes and button triggers, thereby forming a more comprehensive feature information combination.

In Step 206, the processing unit 102 compares the extracted feature information with the pre-stored authentication reference data, and the authentication reference data can be obtained through multiple ways. For example, in one embodiment, the signatory needs to complete a registration procedure before performing the signature process, such as obtaining registration dynamic data of the signatory performing a registration signature process through the sensing device 100, extracting registration feature information from registration dynamic data, and storing registration feature information as authentication reference data. The process of extracting registration dynamic data is not limited to execution through the sensing device 100, can also be completed through another sensing device. In other words, the signatory has to complete the registration procedure by using the sensing device 100 or other sensing devices, allowing the identity verification system 10 to obtain the pre-registered authentication reference data for subsequent signature process comparison.

It should be noted that the purpose of the registration procedure is to generate authentication reference data, whether to initiate the registration procedure, its execution timing, and execution method can be adjusted according to different requirements. For example, in one embodiment, when a signatory performs the signature process, if the identity verification system 10 discovers that authentication reference data has not been established for that signatory, the identity verification system 10 can automatically initiate the registration procedure to establish authentication reference data in real-time, allowing users to continue with the original signing operation after completing a one-time registration procedure. However, in higher security level application scenarios, the identity verification system 10 can require administrator review and authorization before executing the registration procedure. This authorization mechanism can include administrator identity verification, record of approval procedures, and surveillance of the registration process. Additionally, the identity verification system 10 can also require the signatory to provide additional identity documents during registration or complete multiple registration signature processes within a specific time period based on application scenario, to establish more complete and reliable authentication reference data.

In addition to completing the registration procedure by capturing registration dynamic data through the sensing device 100 or other sensing devices, in another embodiment, the authentication reference data can be pre-stored in a database (local or cloud database), and the identity verification system 10 can retrieve the authentication reference data stored in the database through data transmission when comparison is needed (i.e., step 206). Furthermore, to ensure data security, data required for identity verification access or use by the identity verification system 10 (such as dynamic data, feature information, authentication reference data, registration dynamic data, registration feature information, etc.) can undergo encryption processing during transmission and storage, for example using blockchain technology. Correspondingly, if data has undergone encryption processing, decryption processing is required when accessing or using it; for example, if the authentication reference data has undergone encryption processing, then decryption of the authentication reference data is included when comparing feature information with authentication reference data in step 206.

On the other hand, since feature information reflects dynamic characteristics of the signatory when signing, which can include dynamic trajectories, movement methods, holding methods during signing, various variations exist. Therefore, during the comparison process in step 206, the processing unit 102 can also calculate similarity score between feature information and authentication reference data, and compare these similarity score with preset thresholds. Or, in one embodiment, the identity verification system 10 can assign different weights to various features to enhance judgment applicability. In another embodiment, the identity verification system 10 can also introduce artificial intelligence technology to learn correlations between multiple signature processes performed by the signatory in different postures, to adjust authentication reference data, thereby improving comparison accuracy and adaptability. For example, artificial intelligence technology can learn correlations among various signature processes performed by the signatory in different postures, such as standing, sitting, bending, using a pen, or signing with an index finger. By summarizing the signatory's unique signing characteristics, artificial technology can generate or adjust authentication reference data accordingly, thereby enhancing the accuracy of signature verification across different postures.

In Step 208, the identity verification system 10 determines the authenticity of the signature process based on the comparison result between the feature information and the authentication reference data. Furthermore, when the comparison result indicates an inauthentic signature, the identity verification system 10 can take multiple measures, such as generating warning signals like visual prompts, audio alerts, or haptic feedback, and can also send notification messages to designated recipients or administrators for immediate abnormal situation reporting or trigger other preset security mechanisms. Additionally, the identity verification system 10 can dynamically adjust judgment thresholds based on different application scenarios to balance security and convenience requirements.

In brief, through the identity verification process 20, the embodiment of the present invention can capture dynamic information throughout the entire signature process, such as signature speed and force, habitual pauses during writing, stroke order when finishing, or other personalized characteristics. These habitual actions are developed over long periods without consciousness, making them extremely difficult for others to fully imitate, significantly improving verification accuracy and reliability. The embodiment of the present invention can also perform encryption and decryption processing on data needed for identity verification access or use to ensure data security. Furthermore, the embodiment of the present invention can integrate artificial intelligence technology, using machine learning algorithms to enable the identity verification system 10 to learn and recognize signature characteristics of the same person under different circumstances, such as using different writing tools or signing in different postures, thereby enhancing verification accuracy and adaptability.

Moreover, the embodiment of the present invention can combine different dynamic information to form unique feature value combinations. For example, users can generate different feature information within the same signature action by adjusting dynamic characteristics in specific dimensions (such as changing pressing force, adjusting signature speed, or changing pen tip tilt angle), thereby triggering different function permissions. This mechanism is particularly suitable for establishing group authentication mechanisms, allowing group members who know specific dynamic feature combinations to access shared functions through correct signature methods.

Therefore, the identity verification process 20 of the embodiment of the present invention can ensure identity verification reliability and security through multiple feature analysis, flexible data sources, encryption protection mechanisms, artificial intelligence assistance, and comprehensive warning systems, effectively preventing signature forgery while providing sufficient flexibility and scalability for practical applications.

Additionally, it should be noted that the identity verification process 20 represents the main operation method of the identity verification system 10. When implementing the identity verification system 10, those skilled in the art select appropriate components to correctly execute various steps or derivative variations of the identity verification process 20. Specifically, the processing unit 102 can be a Microprocessor, Digital Signal Processor (DSP), or Microcontroller, and the storage unit 104 can be Read-Only Memory (ROM), Random Access Memory (RAM), Flash Memory, or other types of memory devices. The program code 106 is stored in the storage unit 104. When the system starts, the processing unit 102 can read and execute the program code 106 to implement the identity verification process 20. In another embodiment, some computation-intensive or time-critical functions can be implemented by using hardware circuits, while other more complex logical judgments can be processed through software programs. This hybrid implementation method can achieve balance between performance and flexibility, ensuring both system real-time performance and good scalability. Regardless of the implementation method, the processing unit 102 has to obtain correct signals or data captured by the sensing device 100, which can be achieved through standard communication protocols such as Serial Communication Interface (SCI), Serial Peripheral Interface (SPI), or Inter-Integrated Circuit (I2C).

On the other hand, the identity verification system 10 utilizes the sensing device 100 to capture dynamic data, and conducts data analysis and comparison to verify signature authenticity. Therefore, the selection or configuration of the sensing device 100, such as its equipped sensors, buttons, shape, material, and manufacturing method, should prioritize accurate sensing of the signatory's hand movements and signature process. Additionally, although connection lines are depicted between the sensing device 100 and the processing unit 102 in FIG. 1, these only represent signal or data transmission relationships. In practice, the sensing device 100 can communicate with the processing unit 102 through either wired or wireless connections. For example, in wired connection embodiments, the sensing device 100 can establish direct physical connections with the processing unit 102 through standard communication interfaces like USB, UART, SPI, or I2C. This connection method has advantages of stable transmission, low latency, and immunity to external interference, particularly suitable for applications requiring real-time processing of large amounts of sensor data. Furthermore, wired connections can also provide continuous power supply to the sensing device 100, ensuring long-term operational stability.

In wireless connection embodiments, the sensing device 100 can use wireless communication technologies such as Bluetooth, Wi-Fi, ZigBee, or Near Field Communication (NFC) for data transmission with the processing unit 102. Wireless connections provide more flexible user experience, allowing users to perform signature operations within a larger activity range. Considering wireless transmission security requirements, the identity verification system 10 performs encryption processing on transmitted data and establishes secure pairing mechanisms to prevent unauthorized device access. In this implementation, the sensing device 100 can be equipped with rechargeable or replaceable batteries, and battery status can be monitored so as to provide appropriate notifications when battery levels are low.

To ensure reliable data transmission, whether using wired or wireless connections, the identity verification system 10 can incorporate data integrity check mechanisms. When data transmission errors or interruptions are detected, the identity verification system 10 can automatically reestablish connections and request data retransmission to ensure feature information integrity. Additionally, the identity verification system 10 can support dynamic connection switching, such as switching to wired connection mode when wireless connection quality is poor, to maintain normal system operation.

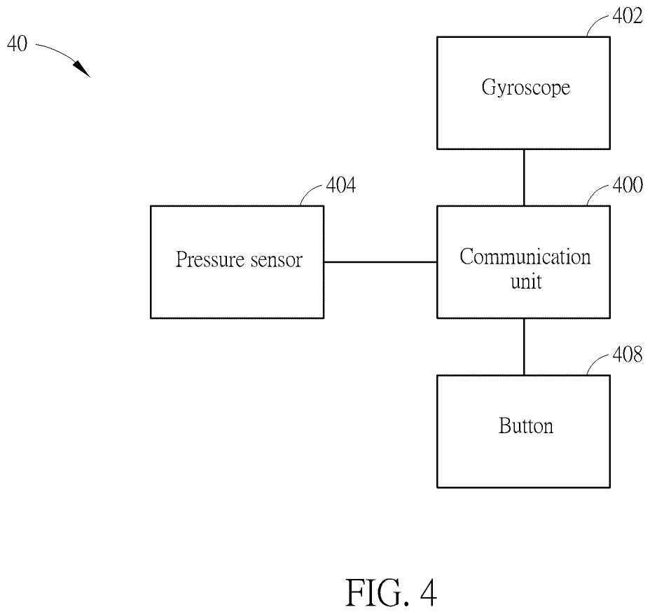

To achieve the data transmission operations, the sensing device 100 can include communication interfaces for data exchange with the processing unit 102. The architecture design of the sensing device 100 based on required functionalities is familiar to those skilled in the art. For example, please refer to FIG. 4, which shows a functional block diagram of a sensing device 40 according to an embodiment of the present invention. The sensing device 40 displays one implementation architecture of the sensing device 100 in FIG. 1, and includes a communication unit 400, a gyroscope 402, a pressure sensor 404, and a button 408. According to system requirements, the communication unit 400 can support wired or wireless communication for transmitting sensor data to the processing unit 102, and can include data encryption and error detection capabilities to ensure data transmission security and reliability. The gyroscope 402 can be a six-axis gyroscope sensor capable of detecting the motion state of the sensing device 40 in three-dimensional space, so as to measure real-time angular velocity, acceleration, and other dynamic parameters, and calculating device posture angles to record the signatory's movement trajectory and posture changes during the signature process. The pressure sensor 404 is used to detect pressure variations applied to the sensing device 40 by the signatory and can include multiple pressure sensing points to simultaneously measure pressure values at different locations, thereby obtaining the signatory's grip force distribution. The button 408 can be a programmable physical button for receiving the signatory's press inputs during the signature process, and can be configured with multiple trigger modes or record parameters such as press duration and force.

It should be noted that the sensing device 40 only represents a feasible architecture of the sensing device 100 and is not limited to this configuration. Those skilled in the art should appropriately add or reduce components based on practical applications. For example, the components of the sensing device 40 can be interconnected through an internal bus and can include a microcontroller for coordination and control. This microcontroller can be responsible for collecting data from various sensors, performing preliminary signal processing, and transmitting processed data to the processing unit 102 through the communication unit 400.

The identity verification system 10 or the identity verification process 20 aims to verify signature authenticity, and those skilled in the art is able to appropriately apply or implement it in various scenarios requiring identity verification. For example, in corporate office environments, the identity verification system 10 or the identity verification process 20 can be applied to electronic document signing systems to ensure document signatory identity authenticity and can be integrated into enterprise security mechanisms as an identity verification method for employee workstation login or confidential data access. In the financial sector, the identity verification system 10 or the identity verification process 20 can be applied to bank counter service identity verification to enhance transaction security or integrated into mobile banking applications to replace traditional password verification, providing users with a more secure and convenient login method. In the retail sector, the identity verification system 10 or the identity verification process 20 can be applied to electronic payment system identity verification, particularly for large transaction authorization confirmation, or used in membership card systems allowing members to quickly complete identity verification through personalized signature methods. In healthcare, the identity verification system 10 or the identity verification process 20 can be used for electronic signing of medical records and prescriptions, ensuring medical document authenticity and integrity, or applied to medical staff duty sign-in or operating room access management. In education, the identity verification system 10 or the identity verification process 20 can be applied to remote learning platform identity verification, ensuring student identity in online examinations, or used for library borrowing systems or laboratory equipment usage management. In property management, the identity verification system 10 or the identity verification process 20 can be applied to resident building access verification, providing higher security than traditional access cards, or used for various public facility use registration. In logistics, the identity verification system 10 or the identity verification process 20 can be applied to package delivery confirmation, not only recording recipient signatures but also verifying recipient identity in real-time. In public sector services, the identity verification system 10 or the identity verification process 20 can be applied to electronic signing of various government documents, improving administrative efficiency while ensuring document legal validity. These diverse application scenarios demonstrate how the present invention can provide more secure and convenient solutions for identity verification needs across various industries.

In addition, according to the identity verification system 10 or the identity verification process 20, the present invention also supports dynamic triggering mechanisms for various functional permissions, which can combine written content with specific dynamic feature sequences. In other words, when users need to activate certain functions, the system not only identifies the written content but also verifies dynamic feature sequences according to preset rules. For example, to activate a function F1, users need to complete the following specific sequence of actions: first write the letter “F,” then press a key once within a specific time window (e.g., within 1 second), followed by writing the number “1,” and finally press the key twice consecutively within a designated time (e.g., within 1 second). The identity verification system 10 or the identity verification process 20 can verify the integrity of the entire action sequence, including the accuracy of written content, compliance with key press counts, and the temporal relationships between actions. As another example, to activate a function F2, in addition to the corresponding written content and button pressing sequence, users need to maintain a specific pen tip tilt angle (such as 45 degrees) during writing or apply predetermined pressure values at specific strokes. The identity verification system 10 or the identity verification process 20 simultaneously monitors these multidimensional dynamic features, triggering the corresponding function only when all features meet preset conditions. To enhance system flexibility, these dynamic feature sequences are configurable. For instance, system administrators can define specific dynamic feature combinations for different functions based on requirements, such as setting a function F3 to require signatory to sign within a writing speed range, or a function F4 to require signatory to sign with a predetermined aerial pen ending gestures. This configurable characteristic supports multi-level permission management and allows for flexible adjustment of verification rules based on actual application scenarios.

Therefore, the present invention provides an identity verification system and method based on hardware sensing, to achieve a more secure and flexible identity verification mechanism through multidimensional dynamic sensing technology. The core of the system of the present invention lies in utilizing the sensing device to collect multidimensional dynamic data during the signature process, including movement trajectories, button pressing interactions, hand gesture changes, and biomechanical features, and converting these data into unique feature information for identity verification. Compared to the conventional identity verification technologies, the present invention employs multidimensional dynamic sensing methods that consider not only the visual characteristics of signatures but also various dynamic features during the signature process, significantly enhancing verification security. Even if someone observes the external actions of the signature, it remains difficult to completely replicate all dimensions of dynamic features, effectively preventing impersonation. Furthermore, the present invention can support diverse functional permission triggering mechanisms. Users can generate different feature combinations by adjusting specific dimensional dynamic features within the same signature action, thereby triggering different functional permissions.

In summary, the present invention realizes a secure, flexible, and practical identity verification solution through multidimensional dynamic sensing technology, helping to enhance the security of various systems while providing signatories with a more convenient verification experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An identity verification method based on hardware sensing, comprising the following steps:
obtaining dynamic data of a signatory performing a signature process by a sensing device;
obtaining a feature information from the dynamic data, wherein the feature information includes a movement feature, an interaction feature, a posture feature, or a biomechanical feature;
comparing the feature information with an authentication reference data to generate a comparison result; and
determining authenticity of the signature process performed by the signatory based on the comparison result.

2. The identity verification method of claim 1, wherein the sensing device includes a gyroscope for obtaining the dynamic data.

3. The identity verification method of claim 1, wherein the sensing device includes a pressure sensor for obtaining the dynamic data.

4. The identity verification method of claim 1, wherein the sensing device includes a button for obtaining the dynamic data.

5. The identity verification method of claim 1, wherein the signatory holds or wears the sensing device to perform the signature process.

6. The identity verification method of claim 1, wherein the feature information includes the interaction feature and the movement feature.

7. The identity verification method of claim 1, wherein the feature information includes the interaction feature and the posture feature.

8. The identity verification method of claim 1, wherein the feature information includes the interaction feature and the biomechanical feature.

9. The identity verification method of claim 1, wherein the feature information includes at least two of the movement feature, the interaction feature, the posture feature, and the biomechanical feature, and the identity verification method further comprises:
integrating the feature information based on a timeline to form a composite information, and then comparing the composite information with the authentication reference data to generate the comparison result.

10. An identity verification system based on hardware sensing, comprising:
a sensing device;
a processing unit, coupled to the sensing device; and
a storage unit, coupled to the processing unit and storing a program code, wherein the program code instructs the processing unit to execute an identity verification method, and the identity verification method includes the following steps:
using the sensing device to obtain dynamic data of a signatory performing a signature process;
obtaining a feature information from the dynamic data, wherein the feature information includes a movement feature, an interaction feature, a posture feature, or a biomechanical feature;
comparing the feature information with an authentication reference data to generate a comparison result; and
determining authenticity of the signature process performed by the signatory based on the comparison result.

11. The identity verification system of claim 10, wherein the sensing device includes a gyroscope for obtaining the dynamic data.

12. The identity verification system of claim 10, wherein the sensing device includes a pressure sensor for obtaining the dynamic data.

13. The identity verification system of claim 10, wherein the sensing device includes a button for obtaining the dynamic data.

14. The identity verification system of claim 10, wherein the signatory holds or wears the sensing device to perform the signature process.

15. The identity verification system of claim 10, wherein the feature information includes the interaction feature and the movement feature.

16. The identity verification system of claim 10, wherein the feature information includes the interaction feature and the posture features.

17. The identity verification system of claim 10, wherein the feature information includes the interaction features and the biomechanical feature.

18. The identity verification system of claim 10, wherein the feature information includes at least two of the movement feature, the interaction feature, the posture feature, and the biomechanical feature, and the identity verification method further includes: integrating the feature information based on a timeline to form a composite information, and then comparing the composite information with the authentication reference data to generate the comparison result.
